(19) United States
(12) Patent Application Publication
(10) Pub. No.: US 2013/0273348 A1
(43) Pub. Date: Oct. 17, 2013

(54) DEVICE FOR TREATING THE SURFACE OF A CORK STOPPER, TREATMENT METHOD, AND STOPPER OBTAINED BY SAID METHOD

(71) Applicants: Fanny Carpentier, Toulouse (FR); Guy De Zotti, Montech (FR); Frederic Aymard, Castelginest (FR)

(72) Inventors: Fanny Carpentier, Toulouse (FR); Guy De Zotti, Montech (FR); Frederic Aymard, Castelginest (FR)

(73) Assignee: C2M AUROCHS INDUSTRIE, Aucamville (FR)

(21) Appl. No.: 13/976,553

(22) PCT Filed: Dec. 28, 2011
(86) PCT No.: PCT/EP2011/074177

§ 371 Date: Jun. 27, 2013

(30) Foreign Application Priority Data
Dec. 29, 2010 (FR) 10/05158

(51) Int. Cl. C09D 163/00

(52) U.S. Cl. CPC C09D 163/00
USPC 428/319.7; 523/457; 523/456; 427/386

(57) ABSTRACT

Disclosed is a device for treating the outer surface of a cork plug (3), including: a first so-called reactive liquid composition including: a so-called bi-epoxyde composition of at least one compound having a molecular mass between 340 g/mol and 800 g/mol; a so called reactive solvent; a so-called curing liquid composition including at least one polyamine adapted for forming a protection film by polymerization at the surface of a cork plug (3); characterized in that the reactive composition includes a load of a solid in the divided state dispersed in the reactive composition, the solid in the divided state including barium sulphate.

The invention relates to a device for treating, especially coating, the surface of a cork-based stopper, for example a stopper made of solid cork and/or of micro-agglomerated cork, to a method for treating, especially coating, the surface such a cork-based stopper using such treatment device, and to a coated cork-based stopper obtained by such a method.

It is known that it is advantageous to treat the outside surface of a cork stopper in order to obtain improved stoppering of bottles, especially glass bottles, containing an aqueous alcoholic solution, especially a strong alcohol (brandy) or a still wine, in particular a “yin de garde” [wine for laying down], or an effervescent wine, especially a wine made “by the Champagne method”, or a sparkling wine containing from 2% to 3% alcohol. Such a cork stopper is liquid-tight and, where appropriate, is selectively permeable to liquids and to gases.

To that end, it has already been proposed to use paraffin compositions, in particular paraffin compositions having a melting point of approximately 51° C. Such paraffin compositions are not suitable for use when the bottle is heated in order to allow it to be stoppered, also called “thermolisation”, especially by heating of the jaws of the stoppering machine.

Such paraffined stoppers are not adapted to be able to be exposed to or stored in sunlight or heat, before or after stoppering. Nor do they have sufficient mechanical abrasion resistance, including at ambient temperature, to permit their use in an automated bottling line in which the paraffined stoppers are worked so that they can be introduced into the stoppering machine.

The use of silicone compositions for coating cork stoppers has also been proposed. The outer surface layer of such silicone-coated stoppers does not impart to such silicone-coated stoppers either properties of facilitated extraction or protection against the migration of tannins and the colouring of strong alcohols.

There is also known from FR 2 637 833 a composition for coating cork products, especially stoppers and sheets, comprising a copolymer resin comprising polyvinyl chloride and polyvinyl alcohol in a mixed solvent which represents, by volume, at least 84% of said composition. The use of such a composition for coating cork stoppers requires the mixed solvent to be evaporated in order to dry the composition. Such a composition is not free of volatile organic compounds (VOCs). In particular, it may contaminate the aqueous alcoholic solution with such VOCs.

Also known are epoxy thermosetting plastics materials comprising at least one epoxy resin, a curing agent, and additives selected from reactive diluents, solvents, flexibilizing agents and fillers.

Such thermosetting plastics materials are known for their adhesion properties to metals, plastic, rubber, wood, glass, ceramics and concrete, and for being usable as a coating for storage boxes, metal or concrete containers, and tanks. They are not suitable for treating the surface of cork and cannot impart to the cork, especially to cork stoppers, chemical resistance to aqueous alcoholic solutions, especially having a high alcohol content. Nor do they allow the aqueous alcoholic solution to be protected in respect of the migration of tannins from the cork of cork stoppers and in respect of colouring of said aqueous alcoholic solution by the tannins.

The invention aims, therefore, to remedy all the disadvantages mentioned above.

The invention aims in particular to propose a device for treating the surface of a cork stopper, which device is adapted to permit the extemporaneous preparation of a liquid mixture for treating the surface of at least one cork stopper.

In the following, a device for treating the surface of a cork stopper denotes all the elements necessary for preparing a mixture for treating the surface of a cork stopper according to the invention. Such a device can be a treatment “kit”.

The invention relates to such a device comprising two separate liquid compositions which are adapted to be able to be prepared, packaged and stored separately from one another in the liquid state and then to be able to be mixed with one another and form a liquid mixture for treating, especially coating, cork stoppers.

The invention aims in particular to propose such a device for treating the surface of a cork stopper which is adapted to permit the formation of a polymerized protective film having high chemical and mechanical resistance on the surface of said cork stopper. In particular, such a protective film is adapted not to alter the organoleptic properties of the aqueous alcoholic solution contained in a bottle stoppered by said cork stopper.

The invention aims, therefore, to propose such a device which is adapted to permit the formation of a polymerized protective film which substantially releases no volatile organic compounds that may contaminate the aqueous alcoholic solution and which complies with the standards relating to materials that may come into contact with foodstuffs, especially within the scope of use at ambient temperature.

The invention also aims to propose such a device which is adapted to permit the obtainment of a polymerized protective film which is stable over time and in contact with an aqueous alcoholic solution, especially in contact with a still wine or with an aqueous alcoholic solution having a high alcohol content, also called strong alcohol.

The invention also aims to propose such a device which is adapted to permit the obtainment of a polymerized protective film which has high chemical resistance to an aqueous alcoholic solution, especially a brandy.

The invention also aims to propose such a device which is adapted to permit the obtainment of a polymerized protective film which has high chemical resistance to a sweet wine (that is to say having a sugar content of up to 60 g/l of wine) and an acidic wine (pH of approximately 3), which are known to alter the adhesive that is a constituent of agglomerated cork stoppers, and the known coatings of natural non-reconstituted cork stoppers.

In particular, the invention aims to propose such a device which is adapted to permit the formation of a polymerized protective film which is adapted to oppose, especially prevent, the migration of tannins from the cork to the aqueous alcoholic solution, especially to a clear brandy, and the colouring thereof.

The invention relates also to such a device for treating the surface of a cork stopper which is adapted to permit the obtainment of a coated cork stopper which can be extracted more easily when the glass bottle is opened. The invention relates more particularly to such a device for treating the surface of a cork stopper which is adapted to permit the obtainment of a coated cork stopper that requires, for its extraction, the application of a force of approximately from 150 N to 500 N (approximately from 15 to 50 kilograms-force, kgf), especially from 200 N to 400 N (approximately from 20 to 40 kilograms-force, kgf), recommended for the extraction of stoppers of different shapes and sizes.

The invention also aims to propose such a device for treating the surface of a cork stopper which is adapted to permit the formation, in the polymerized state on the surface of the cork stopper, of a translucent, in particular substantially transparent, protective film.

The invention further aims to propose such a device for treating the surface of a cork stopper which is adapted to form a treatment mixture having, in the non-polymerized mixed state, a viscosity adapted to permit coating and homogeneous distribution of the treatment mixture on the surface of cork stoppers.

The invention also aims to propose such a device for treating the surface of a cork stopper which is adapted to permit the formation of a protective film on a cork stopper by polymerization of components of the treatment mixture whatever the hygrometric atmospheric conditions.

The invention aims to propose such a device for treating the surface of a cork stopper which is adapted to permit the obtainment of a protective film that has high flexibility and in particular is not brittle.

The invention also aims to propose such a device for the production of coated cork stoppers which have increased abrasion resistance as compared with the coated cork stoppers of the prior art and which are compatible with stoppering on an automated stoppering line.

The invention also aims to propose such a device for treating the surface of a cork stopper which is adapted to permit the obtainment of such a protective film which has increased resistance to tearing as compared with a coating of a cork stopper of the prior art.

The invention also aims to propose such a device for treating the surface of a cork stopper which is free of volatile solvent, especially volatile organic solvent, that may be released before polymerization and/or after polymerization of the treatment mixture.

The invention aims, therefore, to propose such a treatment device which respects the environment.

The invention also aims to propose such a treatment device which respects the organoleptic and visual properties of the aqueous alcoholic solution.

The invention also aims to propose such a treatment device, the use of which complies with regulations relating to the respect of employees' working conditions.

The invention also aims to achieve all those objects by proposing such a device for treating the outside surface of, in particular for coating, a cork stopper which is economically acceptable.

The invention aims in particular to propose such a device for treating the surface of a cork stopper which is adapted to be able to permit the extemporaneous preparation of a ready-to-use surface treatment mixture which can be solubilized with a view to being rinsed, especially with ethyl alcohol, before being dried by polymerization.

The invention also aims to propose a method for treating the outside surface of a cork stopper in which a treatment device according to the invention is used.

The invention also aims to propose a method for treating the surface of a cork stopper at ambient temperature which is simple to carry out and does not require the use of specific heating means.

The invention also relates to such a method which is adapted to be able to be used for treating the outside surface of a cork stopper. In particular, the invention relates to such a method which permits the treatment of a cork stopper having, prior to said treatment of the surface, a distinctive marking, especially a note, a logo and/or at least one character, and without damaging or concealing said distinctive marking.

The invention aims in addition to propose such a method which preserves employees' working practices and the implementation of which involves only a small number of operations.

The invention relates also to such a coated cork stopper which, on the one hand, has properties of chemical inertia towards an aqueous alcoholic solution contained in a bottle that is to be stoppered, and improved mechanical extraction properties, and which, on the other hand, preserves the esthetic appearance of natural cork or micro-agglomerated cork.

Another object of the invention is to provide a coated cork stopper which is adapted not to modify the organoleptic properties of the aqueous alcoholic solution contained in the vessel stoppered with said coated cork stopper.

The invention relates further to such a coated cork stopper which is adapted to permit hermetic stoppering, especially with respect to gases and liquids, of a glass bottle.

The invention also aims and more particularly to propose such a coated cork stopper which is compatible with the constraints of stoppering bottles of aqueous alcoholic solutions, especially of still wine and/or of effervescent wine and/or of sweet wine (having a high sugar content, especially of approximately 60 g/l) and acidic wine (pH of approximately 3) and/or of strong alcohol, on an industrial bottling line.

In particular, the invention aims to propose such a coated cork stopper which does not adhere to the bottle, even after a prolonged contact time, especially of several years, and which is able to be extracted from said bottle by the application of a pull of moderate intensity.

To that end, the invention relates to a device for treating the outside surface of a cork stopper, comprising:
a first liquid composition, called a reactive composition, comprising:
   a composition, called a bi-epoxy composition, of at least one compound having a molecular mass of from 340 g/mol to 800 g/mol and having the following general formula (M):

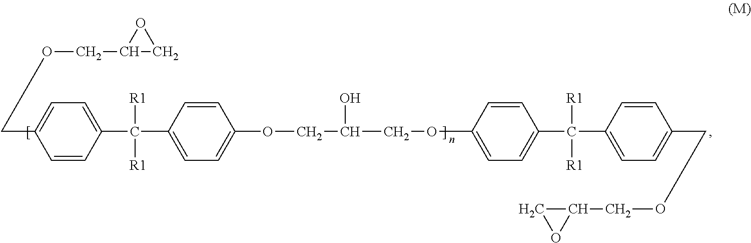

wherein:
n is a natural whole number selected from the group formed of 0, 1 and 2, and
R1 is chosen from the group formed of —H and —CH₃;
   a solvent, called a reactive solvent, of the general formula (N):

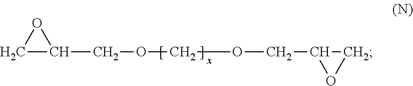

wherein x is a whole number from 2 to 10, in particular 4;
a second liquid composition, called a curing composition, comprising at least one polyamine adapted to react with at least one epoxy group of the reactive composition to form a covalent bond between a primary amine function of said polyamine and said epoxy group, and to form, by polymerization, a protective film on the surface of the cork stopper;
   characterized in that the reactive composition comprises a filler of a solid in the divided state dispersed in the reactive composition, said solid in the divided state being formed of barium sulfate in the divided state.

In the following:
the term “density” of a composition is defined as the ratio, without units, of the mass density of said composition to the mass density of pure water at a temperature of 4° C.;
the expression “epoxy equivalent” of a compound denotes the ratio (expressed in g/mol) between the mass of one mole of said compound and the number of mole(s) of epoxy chemical function of said compound;
the expression “mean diameter” of the particles of the solid in the divided state denotes the mean diameter of the spheres delimiting each of the particles of the solid in the divided state. In particular, in the case of substantially spherical particles, the mean diameter of the particles denotes the mean diameter of the sphere defining the particles.

The invention relates, therefore, to a device for treating the outside surface of a cork stopper, comprising a liquid reactive composition and a liquid curing composition packaged separately from one another.

Advantageously, the reactive solvent of formula (N) is butanediol diglycidyl ether of the following formula (U):

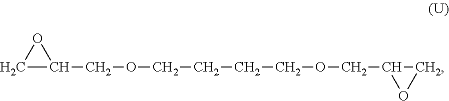 [SMILES: C(CCOCC1CO1)COCC1CO1]

Advantageously, the solid filler is formed of barium sulfate in the divided state. The inventors have observed that such a solid filler is adapted to be able to have a preferential orientation in the barrier-forming protective film and to ensure the cohesion of said protective film. The inventors have also observed that such a solid filler in the reactive composition of a treatment device according to the invention not only permits the formation of a protective film on the surface of a cork stopper, but also permits the obtainment of a coated cork stopper having substantially the colour and appearance of natural cork.

The inventors observed that the use of barium sulfate in the divided state as the solid filler in a treatment device according to the invention permits the preparation of a treatment mixture that has both a low viscosity adapted to the treatment of cork stoppers and an excellent quality of distribution of said mixture over the cork stoppers. In addition, such a treatment mixture permits the formation on the surface of the cork stoppers of a transparent and colourless coating that has improved resistance to alcohols (aqueous alcoholic solutions and/or strong alcohols) as compared with the coatings of the prior art.

Advantageously and according to the invention, the solid in the divided state is formed of particles having a mean diameter of from 0.7 μm to 4 μm.

Advantageously and according to the invention, the treatment device is adapted to form, by mixing of the liquid reactive composition and the liquid curing composition, a surface treatment mixture in the liquid state having a viscosity of less than 30,000 mPa·s, especially from 5000 mPa·s to 25,000 mPa·s, preferably from 10,000 mPa·s to 20,000 mPa·s, ideally from 1700 mPa·s to 2300 mPa·s

The viscosity of such a treatment mixture is measured by any means known to the person skilled in the art, especially by means of a RHEOVISCO rotary viscometer equipped with a no. 5 cylinder having a speed of rotation of 50 or 100 rpm.

Such a treatment device is adapted to be able to form, by extemporaneous mixing of the liquid reactive composition and the liquid curing composition, a surface treatment mixture in the liquid state, said surface treatment mixture not being polymerized, that is adapted to permit the coating of a cork stopper, the formation of a homogeneous film of said treatment mixture on the surface of the cork stopper, and the subsequent formation of a polymerized protective film on the surface of said cork stopper.

Such a mixture for treating the surface of a cork stopper presents a first application state of said treatment mixture, in which the treatment mixture is in a non-polymerized state and has a viscosity adapted to be able to form a layer for coating a cork stopper, and a second protective state of said treatment mixture, in which the mixture forms a polymerized protective film having high chemical and mechanical resistance on the surface of said cork stopper.

The inventors observed that such a device for treating the surface of a cork stopper permits the obtainment of a protective film which extends on the surface of the cork stopper and which has an adhesion to and a cohesion with the underlying cork stopper that are increased as compared with those of the prior coatings of cork stoppers.

In addition, such a cork stopper coated with such a protective film complies with the food quality requirements, especially of European standards (“European Food and Safety Authority”), relating to plastics materials in contact with foodstuffs, in particular at ambient temperature.

Such a treatment device advantageously permits the formation on the surface of the cork stopper of a protective film which has high mechanical abrasion resistance, especially during the phase of bottling and stoppering the bottles, during which the cork stoppers are worked so that they can be introduced into the device for bottling and stoppering the bottles.

Such a treatment device also permits the production of coated cork stoppers having high chemical resistance especially towards aqueous alcoholic solutions.

In particular, such a treatment device permits the production of coated cork stoppers which are adapted to be able to protect an aqueous alcoholic solution against the migration of tannins from the cork into said aqueous alcoholic solution.

Advantageously, the bi-epoxy compound of formula (M) of the reactive composition has at least one of the following features:
it is obtained by polycondensation of bisphenol A and epichlorohydrin;
it comprises two heterocyclic groups having three atoms, of the oxirane (epoxy) type; and
it has a viscosity of less than 50,000 mPa·s, especially of from 5000 mPa·s to 25,000 mPa·s, in particular of from 10,000 mPa·s to 20,000 mPa·s, preferably of from 11,000 mPa·s to 14,000 mPa·s, more preferably of approximately 11,500 mPa·s, at a temperature of 25° C.

Advantageously, such a viscosity of the bi-epoxy compound of formula (M) of the reactive composition is adapted to permit the formation of a mixture for treating the outside surface of a cork stopper which has low viscosity prior to polymerization, without its being necessary, in order to obtain such a viscosity, to use a solvent that may evaporate during (and after) the polymerization.

Advantageously and according to the invention, the treatment device has at least one of the following features:
the proportion by mass of the bi-epoxy composition in the reactive composition is greater than 30%, especially from 30% to 50%, in particular approximately 40%;
the proportion by mass of the reactive solvent of the reactive composition in the reactive composition is from 1% to 10%, in particular substantially approximately 5%;
the reactive composition has a density of from 1.50 to 1.60;
the reactive composition has a viscosity of less than 10,000 mPa·s, especially of from 4000 mPa·s to 6000 mPa·s, at a temperature of 25° C.;
the reactive composition further comprises a proportion by mass of from 0.1% to 1%, especially of approximately 0.5%, of at least one antifoaming agent, especially a silicone-free antifoaming agent;
the reactive composition is light-yellow in colour.

In particular and advantageously, the reactive composition of a treatment formulation according to the invention comprises a proportion by mass of from 35% to 45% of bi-epoxy composition, a proportion by mass of from 12% to 18% of a flexibilizing composition, a proportion by mass of from 2% to 8% of reactive solvent, a proportion by mass of from 31.5% to 45.5% of solid filler(s) in the divided state, especially of barium sulfate, a proportion by mass of from 0.8% to 1.2% of amorphous hydrophobic silica in the divided state, and a proportion by mass of from 0.2% to 0.8% of antifoaming agent. Such a particular composition is preferably adapted for the treatment of a cork stopper for the bottling of a composition having a high content of alcohol (strong alcohols), especially of ethyl alcohol.

In a preferred embodiment, the resin D.E.R 331 EPDXY RESIN (Dow Chemical, La Plaine Saint Denis, France) is used as the bi-epoxy composition, Cardolite NC-513 (SPI® Supplies, Paris, France) is used as the flexibilizing composition, Epodil 750 (AIR PRODUCTS, Utrecht, Netherlands) is used as the reactive solvent, CABOSIL M5 (CABOT, Louvain, Belgium) is used as the amorphous hydrophobic silica in the divided state, BYK A 535 (BYK Chemie GmbH, Wessel, Germany) is used as the antifoaming agent.

Advantageously, it is possible to use as the bi-epoxy composition Araldite GY 250 (HUNTSMAN, Basel, Switzerland) and/or POLYPDX (E064 Dow Chemical, La Plaine Saint Denis, France), alone or in a mixture. Advantageously, it is possible to use as the reactive solvent Araldite DY-D (HUNTSMAN, Basel, Switzerland) and/or POLYPDX R3 (EVONIK Degussa GmbH, Germany). Advantageously, it is possible to use as the solid filler(s) in the divided state Blanc Fix Powder Micro or Blanc Fix Powder N (Sachtleben Chemie GmbH, Duisburg, Germany) as the barium sulfate (BaSO₄).

Advantageously, a treatment device according to the invention comprises a separate reactive composition and curing composition and is adapted:
to form the treatment mixture by mixing the reactive composition and the curing composition with one another;
to permit the coating of the outside surface of a cork stopper; and
to permit stabilization at ambient temperature of the coating layer formed.

Advantageously, a device for treating the surface of a cork stopper according to the invention presents a state in which the reactive composition and the curing composition are mixed with one another to form a treatment mixture, said treatment mixture having a viscosity adapted to permit coating of said stoppers by simple contact of the stoppers and the treatment mixture.

Advantageously and according to the invention, the curing composition comprises:
a composition, called a non-cyclic aliphatic polyamine composition, of at least one aliphatic polyamine chosen from the group formed of 2,2,4-trimethyl-1,6-hexanediamine and 2,4,4-trimethyl-1,6-hexanediamine;
a composition, called a cyclic aliphatic polyamine composition, of at least one cyclic aliphatic polyamine, especially 3-aminomethyl-3,5,5-trimethylcyclohexylamine;
a composition, called a phenalkylamine composition, formed of at least one cardanol derivative of the following general formula (P):

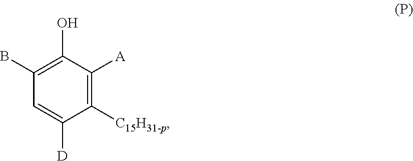

wherein:
p is a whole number chosen from 0, 2, 4 and 6;
A, B and D are groups chosen independently of one another from the group formed of hydrogen (H) and groups having a terminal primary amine and a main chain connecting the phenol group of the cardanol and said terminal primary amine, said main chain being formed of a number of from 5 to 10 of atoms chosen from carbon atoms and nitrogen atoms.

Such phenylpolyaminoalkyl derivatives of cardanol of the general formula (P) are described in document EP 1 091 926.

Advantageously and according to the invention, the curing composition comprises a proportion by mass of less than 1% of 1,2-diaminoethane of formula (Q):

NH₂—CH₂—CH₂—NH₂ (Q).

Advantageously and according to the invention, the curing composition comprises a proportion by mass of from 1% to 2% of diethylenetriamine of formula (R):

[H₂N—CH₂—CH₂—]₂NH (R).

Advantageously and according to the invention, the curing composition has at least one of the following features:
the proportion by mass of non-cyclic aliphatic polyamine composition in the curing composition is from 25% to 50%;
the proportion by mass of cyclic aliphatic polyamine composition in the curing composition is from 10% to 25%;
the curing composition comprises a proportion by mass of para-tert-butylphenol.

Advantageously, the proportion by mass of para-tert-butylphenol in the curing composition is from 5% to 20%, especially from 5% to 12.5%;
the curing composition comprises a proportion by mass of the phenalkylamine composition of from 33% to 43%;
the curing composition has a density of from 1.0 to 1.1;
the curing composition has a viscosity of from 1200 mPa·s to 2200 mPa·s at a temperature of 25° C.

Advantageously and according to the invention, the reactive composition comprises a proportion by mass of said solid filler of from 10% to 50%. Advantageously, the solid filler is formed of barium sulfate, the proportion by mass of which in the reactive composition is from 10% to 50%.

Advantageously, in a first variant of a treatment device according to the invention, the proportion by mass of solid filler in the reactive composition is from 10% to 20%. In particular, the solid filler is formed of barium sulfate in the divided state. A treatment mixture obtained from such a reactive composition is in particular adapted for the treatment of cork stoppers for the bottling of still wines.

In a second variant of a treatment device according to the invention, the proportion by mass of solid filler in the reactive composition is greater than 30%, especially from 30% to 45%, in particular from 35% to 40%, preferably approximately 38.5%. A treatment mixture obtained from such a reactive composition, in which the solid filler is formed of barium sulfate, is adapted in particular for the treatment of cork stoppers for the bottling of strong alcohols.

Advantageously and according to the invention, the reactive composition comprises a composition, called a flexibilizing composition, of at least one liquid compound of the following general formula (S):

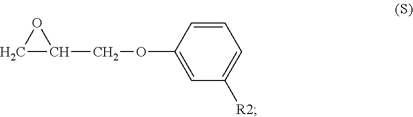

wherein R2 is a hydrocarbon group, saturated or unsaturated, comprising a main chain having from 10 to 20, especially 15, carbon atoms.

Advantageously, the flexibilizing composition of the reactive composition comprises at least one liquid compound derived from cardanol of the following general formula (T):

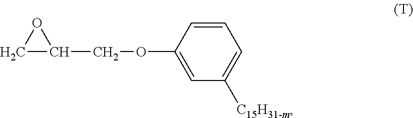

wherein m is a whole number chosen from 0, 2, 4 and 6.

Advantageously and according to the invention, the flexibilizing composition has at least one of the following features:
the liquid compound derived from cardanol has a mean epoxy equivalent value of from 425 to 575;
the liquid compound derived from cardanol has a viscosity of from 40 mPa·s to 70 mPa·s at a temperature of 25° C.;
the proportion by mass of liquid compound derived from cardanol in the reactive composition is approximately 15%.

Advantageously and according to the invention, the proportion by mass of a composition, called a diluent composition, formed of the liquid compound derived from cardanol and the reactive solvent, in the reactive composition is from 15% to 25%, especially approximately 20%.

Advantageously and according to the invention, the reactive composition comprises a proportion by mass of less than 5%, especially of approximately 1%, of amorphous hydrophobic silica in the divided state, especially of silica surface-modified by polydimethylsiloxane groups. Such a proportion of amorphous silica in the divided state is used to permit rheological control of the reactive composition and of the treatment mixture obtained by mixing the reactive composition and the curing composition. Advantageously, the amorphous silica in the divided state is a fumed silica having a specific surface area of from 100 m²/g to 200 m²/g.

Advantageously and according to the invention, the reactive composition comprises a proportion by mass of at least one colouring chosen from the group formed of food colourings, especially food colourings based on at least one titanium oxide. In this variant of a method according to the invention, it is possible to voluntarily provide the coating that is to be formed on the surface of cork stoppers with a colouring, said coating being wholly colourless and transparent without the provision of a food colouring.

In a particular embodiment of the invention, the reactive composition comprises a filler of solid glass in the divided state having a particle size of from 50 μm to 100 μm, especially approximately 60 μm. Advantageously, the reactive composition comprises a proportion by mass of said glass filler of approximately 5%. Advantageously, such a glass filler is used in the reactive composition to prepare a mixture for treating the surface of cork stoppers for the stoppering of a still wine, in particular a “vin de garde”.

The invention extends in addition to a method for treating the outside surface of a cork stopper, in which:
a treatment device according to the invention is chosen;
a treatment mixture is formed by mixing an amount by mass of the reactive composition with an amount by mass of the curing composition, the ratio between the amount by mass of the reactive composition and the amount by mass of the curing composition in the treatment mixture being from 2 to 10, preferably from 4 to 5; and then
a step of coating the cork stoppers is carried out, in which said cork stoppers are brought into contact with the treatment mixture with agitation in an agitator drum at ambient temperature for a period of from 15 minutes to 30 minutes so as to form coated stoppers; then
a step of polymerization and drying of the treatment mixture is carried out by placing said cork stoppers, separately from one another, in atmospheric air and at ambient temperature for a period of at least 24 hours, adapted to obtain coated stoppers that are ready to use.

Advantageously and according to the invention, during the coating step, said cork stoppers are brought into contact with the treatment mixture with agitation in an agitator drum at a temperature of from 20° C. to 30° C., especially at ambient temperature, for a period of from 15 to 30 minutes.

Advantageously and according to the invention, during the step of polymerization and drying, said cork stoppers are placed, without agitation, in atmospheric air and at ambient temperature, especially from 10° C. to 35° C., for a period of approximately 24 hours, said cork stoppers being separate from one another.

In a first embodiment of a method according to the invention, advantageously and according to the invention, the cork stoppers being micro-agglomerated cork stoppers for the stoppering of a bottle, especially a glass bottle, containing a strong alcohol, especially a brandy, there is used an amount of the treatment mixture adapted so that the ratio of the total surface area, expressed in square meters (m²), of the cork stoppers to be treated and the mass, expressed in grams, of the treatment mixture is from 0.02 to 0.03, especially substantially approximately 0.025.

In particular, the cork stoppers being micro-agglomerated cork stoppers for the stoppering of a bottle, especially a glass bottle, containing a strong alcohol, especially a brandy, said cork stoppers having a length of 29 mm and a transverse cross-sectional diameter of 21 mm, there are used 1000 g of the treatment mixture to treat 10,000 cork stoppers.

In a second embodiment of a method according to the invention, advantageously and according to the invention, the cork stoppers being micro-agglomerated cork stoppers for the stoppering of a bottle, especially a glass bottle, containing a still wine, especially a “vin de garde”, there is used an amount of the treatment mixture such that the ratio of the total surface area, expressed in square meters (m²), of the stoppers to be treated and the mass, expressed in grams, of the treatment mixture is from 0.2 to 0.3, especially substantially approximately 0.25.

Advantageously and according to the invention, prior to the mixing step, there is added to the reactive composition a proportion by mass of approximately 5% of a glass filler in the divided state having a particle size of from 50 μm to 100 μm.

Advantageously and according to the invention, after the polymerization step, the coated cork stoppers are treated with an amount of at least one silicone elastomer in a proportion of 40 g of silicone elastomer to 10,000 coated cork stoppers.

The invention also extends to a device for treating a cork stopper, comprising:
an amount of a reactive composition in a first container, especially a first packaging;
an amount of a curing composition in a second container, especially a second packaging;
instructions for use of the treatment device, describing a method according to the invention.

Advantageously, the first and second containers for the reactive composition and the curing composition are hermetically closed containers which are adapted to permit the storage of the reactive composition and of the curing composition in the liquid state with the exclusion of air.

The invention also extends to the use of such a device for treating the surface of a cork stopper.

The invention also extends to a coated cork stopper having an outer protective film comprising a filler of a solid in the divided state, said solid in the divided state being formed of barium sulfate in the divided state.

Advantageously and according to the invention, the coated cork stopper requires for its extraction from a bottle the application of a force oriented according to the axis of elongation of the neck of said bottle having an intensity of from 150 N to 500 N (approximately from 15 to 50 kilograms-force, kgf), especially from 200 N to 400 N (approximately from 20 to 40 kilograms-force, kgf), recommended for the extraction of stoppers of different shapes and sizes.

The invention also extends to a coated cork stopper obtained by a method according to the invention.

Advantageously and according to the invention, the outer protective film of the coated cork stopper is free of volatile organic compounds.

The invention also relates to a device for treating the surface, especially coating, of a cork stopper, to a method for coating a cork stopper using such a treatment device, to a kit for treating the surface of a cork stopper, and to a coated cork stopper obtained by such a method, characterized in combination by all or some of the features mentioned hereinabove or hereinbelow.

Other objects, features and advantages of the invention will become apparent from reading the following description, which refers to the accompanying figures, which show a preferred embodiment of the invention and are given solely by way of non-limiting examples and in which:

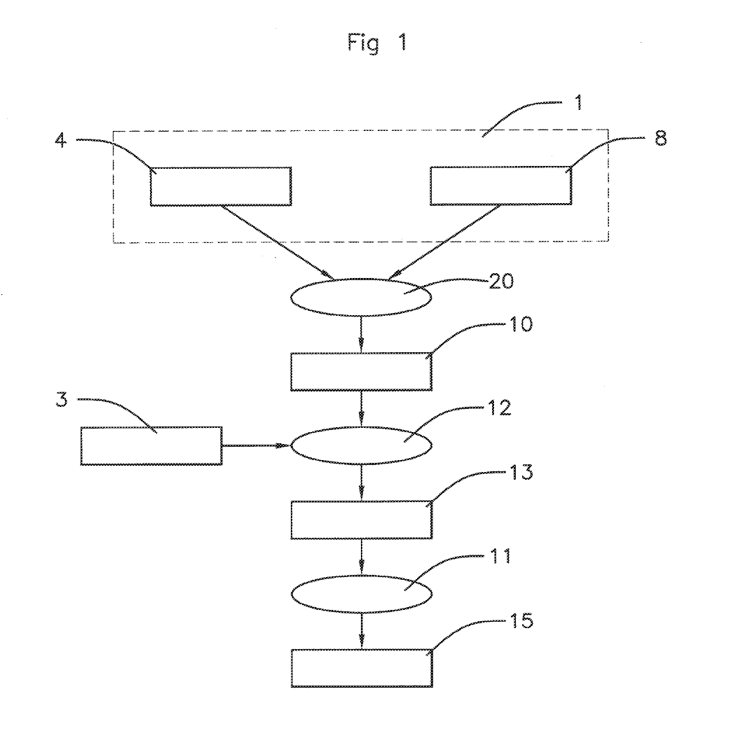

FIG. 1 is a synoptic diagram of a method for coating cork stoppers according to the invention,

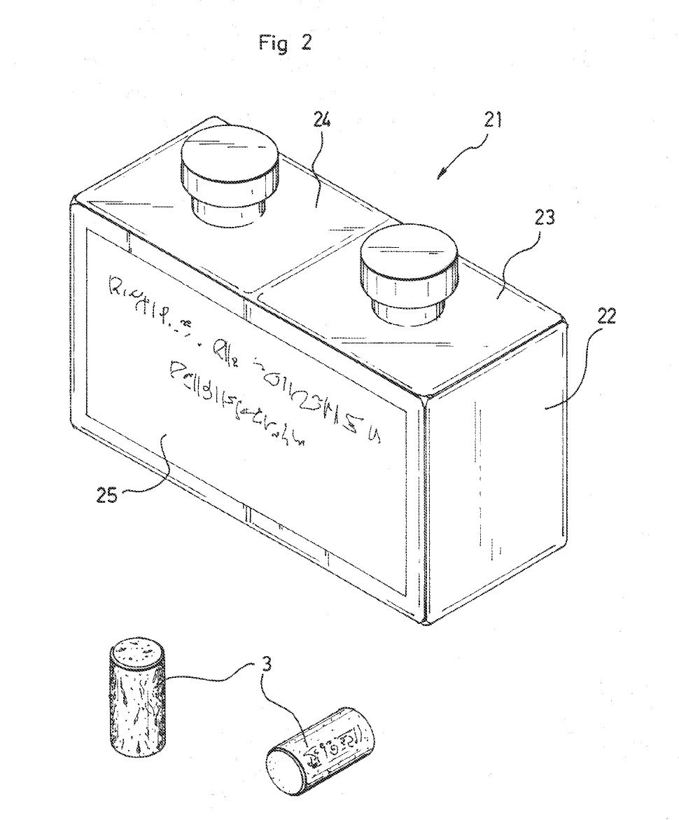

FIG. 2 is a representation of a device for treating cork stoppers according to the invention, in the form of a treatment kit.

A method for treating the outside surface of cork stoppers 3 is described in FIG. 1. In such a method there is used a composition 1 for treating the outside surface 2 of at least one cork stopper 3 according to the invention. Such a treatment composition 1 comprises a reactive composition 4 and a curing composition 8. For treating the outside surface of cork stoppers 3, a treatment mixture 10 is prepared extemporaneously by mixing 20 an amount of the reactive composition 4 and an amount of the curing composition 8. Mixing 20 is carried out at ambient temperature by any known means, especially mechanical means, for example magnetic stirring, ultrasound, for homogenizing the reactive composition 4 and the curing composition 8. The treatment mixture 10 is then applied by spraying or by injection at ambient temperature and at atmospheric pressure to stoppers 3 of natural cork or of agglomerated/micro-agglomerated cork. The application is carried out in a rotary drum having an inside homogenization volume of 20 liters, at a rate of 1000 g of treatment mixture 10 to 10,000 micro-agglomerated cork stoppers 3 of dimensions (21×29 mm) for the bottling of a clear brandy. The speed of rotation of the drum about its axis of symmetry is from 20 to 25 rpm.

For the coating of cork stoppers 3 for the bottling of a still wine, especially a “vin de garde”, an amount of 100 g of the treatment mixture 10 is applied.

A step 12 of coating the cork stoppers 3 is carried out, in which homogenization is maintained for a period of from 15 minutes to 30 minutes. Coated cork stoppers 13 are obtained, that is to say stoppers having a layer of the treatment mixture 10 extending over the outside surface 2 of the coated cork stoppers 13, said treatment mixture 10 not being polymerized. The thickness of the layer of treatment mixture 10 on a stopper for the bottling of a still wine, especially a “vin de garde”, is less than 1 μm.

The thickness of the layer of treatment mixture 10 on a stopper for the bottling of a clear brandy is less than 10 μm.

A step 11 of polymerization of the treatment mixture 10 is then carried out by placing the coated cork stoppers 13 in atmospheric air and at ambient temperature (that is to say without the specific use of means for heating the coated cork stoppers 13) for a period of approximately 24 hours. There are thus obtained coated cork stoppers 13 having a dry appearance to the touch. Polymerization of the treatment mixture 10 is complete after a period of approximately 96 hours at ambient temperature and atmospheric pressure.

There are obtained cork stoppers 15 which are ready to use and which have a protective film of a pale yellow colour, with a glossy and smooth appearance and with high resistance to mechanical abrasion.

In addition, the cork stoppers 15 coated with such a protective film satisfy the food quality requirements, especially the European standards (“European Food and Safety Authority”), relating to plastics materials in contact with foodstuffs, in particular at ambient temperature. In particular, the specific migration value (SMV) of bisphenol A of such a coated cork stopper 15 according to the invention is less than 0.2 mg of bisphenol

A per kilogram of food as conducted at the Laboratoire National de Métrologie et d'Essais [National Laboratory of Metrology and Testing] (LNE, Trappes, France) in accordance with standard NF EN 15136.

The total migration measurements conducted at the Laboratoire National de Métrologie et d'Essais (LNE, Trappes, France) in accordance with standard NF ISO 10106 show a value of 6 mg/kg, which is lower than the limits laid down by the regulations in the simulant liquid representing aqueous and alcoholic foodstuffs up to 50° (Simulant C of directive 85/572).

The measurements of migration of primary aromatic amines conducted at the Laboratoire National de Métrologie et d'Essais (LNE, Trappes, France) in accordance with standard EN 1186-1 show a value of less than 0.002 mg/kg (mg of aniline per kg of food), which is below the detection limit of 0.01 mg/kg mentioned in Directive no. 2002/72/EC.

The analyses of lead, cadmium, mercury and chromium conducted at the Laboratoire National de Métrologie et d'Essais (LNE, Trappes, France) in accordance with Directive 2004/12/EC show a content of each of those heavy metals of less than 10 mg/kg, which is below the limit of 100 mg/kg laid down by the regulations in Directive no. 2002/72/EC.

The protective nature of such a protective film is evaluated by means of a plurality of standardized tests, called resistance tests, which are described hereinbelow and in which cork stoppers which have a length of 29 mm and a transverse cross-sectional diameter of 21 mm and which have previously been treated with a treatment device according to the invention are placed in a volume of a liquid.

According to a first step of a resistance test, two coated cork stoppers 3 according to the invention are placed and maintained in a volume of 200 ml of distilled water at a temperature of 100° C. for 24 hours. The colour of the distilled water is evaluated visually. Following this first step, the distilled water does not appear to be substantially coloured after contact with the two coated cork stoppers according to the invention.

According to a second step of a resistance test, two coated cork stoppers 3 according to the invention are placed and maintained in a volume of 200 ml of an aqueous alcoholic liquid formed of 50% (v/v) water and 50% (v/v) ethanol at ambient temperature for a period of at least one month. Following this second step, the liquid does not appear to be substantially coloured.

According to a third step of a resistance test, three coated cork stoppers 3 according to the invention are placed and maintained in a volume of 200 ml of an aqueous alcoholic liquid formed of 50% (v/v) water and 50% (v/v) ethanol at ambient temperature for a period of one month. Following this third step, the aqueous alcoholic liquid does not appear to be substantially coloured.

According to a fourth step of a resistance test, two coated cork stoppers 3 according to the invention are placed and maintained in 200 ml of demineralized water at a temperature of 60° C. for 10 hours per day for a period of one month. Following this fourth step, the demineralized water does not appear to be substantially coloured.

A device for treating cork stoppers 3 is shown in FIG. 2. Such a treatment device according to the invention is in the form of a treatment kit 21 and comprises a packaging 22 adapted to be able to receive a first bottle 23 containing an amount of a reactive composition 4, and a bottle 24 containing an amount of a curing composition 8. Such a kit 21 further comprises printed instructions 25 in which the conditions of use of the treatment device are mentioned. Such instructions 25 can be a printed sheet in the form of a loose sheet placed inside the packaging 22 or can extend over the outside surface of said packaging 22. In such a kit 21 for the treatment of cork stoppers 3, the two liquid compositions, the reactive composition 4 and the curing composition 5, are packaged separately from one another especially in two hermetically closed bottles 23, 24, prior to their first use.

In a first variant (not shown) of a kit 21 according to the invention, it is possible for the kit 21 also to comprise means for metering and mixing the two compositions, the reactive composition 4 and the curing composition 8.

In a second variant (not shown) of a kit 21 according to the invention, it is possible for the kit 21 to also comprise cleaning means, especially an aqueous alcoholic composition, which are adapted to permit the solubilization of the treatment mixture 10 prior to polymerization and its removal from the rotary homogenization drum, and of the implements that have come into contact with the treatment mixture 10.

### Example 1

### Device for Treating the Outside Surface of a Cork Stopper

The reactive composition of a device for treating the outside surface of a cork stopper according to the invention comprises:
40 g of liquid bi-epoxy resin (D.E.R. 331 EPDXY RESIN Dow Chemical, La Plaine Saint Denis, France). Such a liquid bi-epoxy resin is composed of a plurality of compounds of the general formula (M), the weighted average value of n of which is 0.15. Such a bi-epoxy resin has a mean epoxy equivalent value of from 425 Da to 575 Da. The viscosity of the bi-epoxy resin is from 11,000 mPa·s to 14,000 mPa·s at a temperature of 25° C. Its density at a temperature of 25° C. is 1.16. The proportion of residual epichlorohydrin in the liquid bi-epoxy resin is less than 5 ppm. The storage life of the liquid bi-epoxy resin is approximately 24 months;
15 g of a flexibilizing compound (Cardolite NC 513, SPI Supplies, Paris, France) of low volatility. The viscosity of the flexibilizing composition is from 40 mPa·s to 70 mPa·s, especially 50 mPa·s, at a temperature of 25° C. The mean epoxy equivalent weight of the flexibilizing composition is from 425 Da to 575 Da, especially approximately 490 Da. The flexibilizing composition has a colour of reference 11 on the Gardner scale;
5 g of reactive solvent formed of 1,4-bis(2,3-epoxypropoxy)butane (1,4-butanediol diglycidyl ether) (EPODIL 750, Air Products Chemicals Europe BV, Utrecht, Netherlands);
38.5 g of solid barium sulfate in the divided state (Blanc Fixe, Sachtleben Chemie GmbH, Duisburg, Germany) having a particle size of substantially from 0.7 μm to 4 μm;
1 g of food-grade fumed silica (CAB-O-SIL TS 720, CABOT Corporation, Louvain, Belgium) or Tixosil 38AB (Rhodia S. A., Paris La Défense, France);
0.5 g of a silicone-free polymeric antifoaming agent (BYK-A 535, BYK Chemie GmbH, Germany).

The curing composition of a device for treating the outside surface of a cork stopper according to the invention comprises:
50 g of a mixture of aminated compounds (POLYPDX IH 7016 Dow Chemicals, La Plaine Saint Denis, France), comprising:
   from 25 to 50 g of trimethyl-1,6-hexanediamine;
   from 10 to 25 g of 3-aminomethyl-3,5,5-trimethylcyclohexylamine;
   from 10 to 20 g of 4-tert-butylphenol;
40 g of a phenalkamine (Cardolite NC-558, SPI Supplies, Paris, France);
10 g of POLYPDX H 229 (Dow Chemicals, La Plaine Saint Denis, France).

### Example 2

### Method for Treating the Outside Surface of a Cork Stopper

In a method for treating cork stoppers, the following steps are carried out in succession at ambient temperature, that is to say at a temperature of from 10° C. to 30° C.

1. In the first instance, 2 kg of a reactive composition according to the invention are prepared.

800 g±10 g of liquid bi-epoxy resin (D.E.R. 331 EPDXY RESIN) and then 10 g±0.4 g of polymeric antifoaming agent (BYK-A 535) are introduced into the bowl of a 5-liter planetary mixer (Kenwood). The mixture is homogenized by rotative agitation of the bowl at low speed (speed no. 3) for a period of 15 minutes.

When the mixture is homogeneous, the rotative agitation is stopped, and 20 g±1 g of fumed silica (CAB-O-SIL TS 720) are introduced into the bowl of the planetary mixer. Agitation of the mixture at low speed (speed no. 3) is continued for a period of 15 minutes.

The rotative agitation is stopped, and 385 g±5 g of barium sulfate in the divided state (Blanc Fixe) are introduced into the bowl of the planetary mixer containing the mixture. Rotative agitation of the mixture is continued at medium speed (speed no. 4-5) for a period of 15 minutes.

The rotative agitation is stopped, and a further 385 g±5 g of barium sulfate in the divided state (Blanc Fixe) are introduced into the bowl of the planetary mixer containing the mixture. Rotative agitation of the mixture is continued at medium speed (speed no. 4-5) for a period of 30 minutes.

Without stopping the rotative agitation, 150 g±2 g of Cardolite NC 513 as the flexibilizing compound are introduced into the bowl of the mixer. The rotative agitation of the mixture is maintained at medium speed (speed no. 4) for a period of 15 minutes.

Without stopping the rotative agitation, an additional 150 g±2 g of Cardolite NC 513 are introduced into the bowl of the mixer, and the rotative agitation of the mixture is carried out at high speed (speed no. 5-6) for a period of 15 minutes.

Still with rapid agitation, 100 g±2 g of POLYPDX R3 are introduced as the reactive solvent into the bowl of the mixer, and rapid agitation (speed no. 5-6) is maintained for a period of 30 minutes.

The agitation is stopped, and the reactive composition so obtained is transferred to a 5-liter container. The reactive composition is allowed to stand for 30 minutes, and then said container is closed hermetically.

2. In addition, 500 g of a curing composition according to the invention are prepared in the second instance.

250 g±2.5 g of POLYPDX IH 7016, 200 g±2.0 g of Cardolite NC-558 and 50 g

±0.5 g of POLYPDX H 229 are introduced into a polyethylene flask having a volume of 5 liters. The mixture is homogenized by mechanical agitation for 3 hours.

3. The cork stoppers are then given a satin finish as follows.

1 kg±10 g of the reactive composition as prepared in point 1 are introduced into a metal bucket having a volume of 2 liters, and 240 g of the curing composition as prepared in point 2 are added. The treatment mixture so obtained is homogenized by vigorous mechanical agitation for a period of 3 minutes.

50 micro-agglomerated cork stoppers of dimensions 29×21 mm are introduced into a stainless steel rotary drum. 5 g of the treatment mixture are introduced into the rotary drum at a speed of rotation of approximately from 20 to 25 rotations per minute over a period of 30 minutes. Homogeneous distribution of the treatment mixture over all the cork stoppers is obtained. The cork stoppers are removed from the drum and allowed to stand in the open air for a period of 7 days at a temperature of 20° C. or for a period of 5 days at a temperature of 35° C.

4. Evaluation of the quality of the treated cork stoppers.

3 cork stoppers treated according to point 3 are taken and introduced into a glass bottle containing 200 ml of a colourless aqueous alcoholic solution (water/EtOH; 50/50; v/v). In parallel, 3 micro-agglomerated cork stoppers of dimensions 29×21 mm which have not undergone treatment according to point 3 are placed as control.

It is observed that the aqueous alcoholic solution in the bottle containing the cork stoppers treated with the treatment device according to the invention remains visually colourless after a period of 6 months. By contrast, the aqueous alcoholic solution containing the untreated cork stoppers appears visually to be yellow in colour after a period of a few days.

### Example 3

### Comparative Study of Fillers of Solids in the Divided State

Different solid fillers in the divided state were studied in respect of their properties of resistance to aqueous alcoholic solutions, in respect of their rheological properties in the treatment mixture, and in respect of their viscosity and their stability. The results are presented in Table 1 below.

Wholly unexpectedly and surprisingly, the inventors have found that a treatment device comprising barium sulfate as the solid filler in the divided state has excellent resistance to aqueous alcoholic solutions, permits the formation of a non-brittle protective film on the surface of a cork stopper, that the protective film obtained is totally transparent and colourless and preserves the natural colour of the cork stopper, and that the barium sulfate has optimum dispersion in the reactive composition and in the treatment mixture.

TABLE 1

| | Resistance to | | |
|---|---|---|---|
| | the water/EtOH | Rheology in the | Other |
| Filler | mixture | treatment mixture | properties |
| Barium sulfate | excellent | Good dispersion | |
| Aluminium | average | Good dispersion, | |
| hydroxide | | thixotropy | |
| Non-fumed silica | average | Good dispersion | |
| Fumed silica | average | Good dispersion, | Agent for |
| | | thixotropy | preventing |
| | | | sedimentation |
| Glass, | average | Difficult | Brittle product |
| microspheres | | dispersion | above 20% |
| Calcium | none | Good dispersion, | Increase in |
| carbonate | | stable mixture | hardness, brittle |
| | | | product |
| Dolomite | none | Good dispersion, | |
| | | increase in | |
| | | viscosity, | |
| | | sedimentation | |
| Talc | none | Good dispersion | Good mechanical |
| | | | properties |

### Example 4

### Device for Treating the Outside Surface of a Cork Stopper

The reactive composition of a device for treating the outside surface of a cork stopper according to the invention comprises:
68 g of liquid bi-epoxy resin (D.E.R. 331 EPDXY RESIN Dow Chemical, La Plaine Saint Denis, France) as described in Example 1;
1 g of food-grade fumed silica (CAB-O-SIL M 5, CABOT Corporation, Louvain, Belgium) or Tixosil 38AB (Rhodia S. A., Paris la Défense, France);
10 g of solid barium sulfate in the divided state (Blanc Fixe, Sachtleben Chemie GmbH, Duisburg, Germany) having a particle size of substantially from 0.7 μm to 4 μm;
21 g of reactive solvent formed of 1,4-bis(2,3-epoxypropoxy)butane (1,4-butanediol diglycidyl ether) (POLYPDX R3).

The curing composition of a device for treating the outside surface of cork stoppers according to the invention is as described in Example 1. The treatment of cork stoppers is carried out according to the method described in point 3 of Example 2.

A tannin migration test is carried out as described in point 4 of Example 2. It is observed that the aqueous alcoholic solution of the bottle containing the cork stoppers treated with the treatment device according to the invention remains visually colourless after a period of 6 months. By contrast, the aqueous alcoholic solution containing the untreated cork stoppers appears visually to be yellow in colour after a period of a few days.

### Example 5

### Device for Treating the Outside Surface of a Cork Stopper

The reactive composition of a device for treating the outside surface of a cork stopper according to the invention comprises:
68 g of liquid bi-epoxy resin (D.E.R. 331 EPDXY RESIN Dow Chemical, La Plaine Saint Denis, France) as described in Example 1;
1 g of food-grade fumed silica (CAB-O-SIL M5, CABOT Corporation, Louvain, Belgium) or Tixosil 38AB (Rhodia S. A., Paris la Defense, France);
16 g of solid barium sulfate in the divided state (Blanc Fixe, Sachtleben Chemie GmbH, Duisburg, Germany) having a particle size of substantially from 0.7 μm to 4 μm;
15 g of reactive solvent formed of 1,4-bis(2,3-epoxypropoxy)butane (1,4-butanediol diglycidyl ether) (POLYPDX R3).

The curing composition of a device for treating the outside surface of cork stoppers according to the invention is as described in Example 1. The treatment of cork stoppers is carried out according to the method described in point 3 of Example 2.

A tannin migration test is carried out as described in point 4 of Example 2. It is observed that the aqueous alcoholic solution of the bottle containing the cork stoppers treated with the treatment device according to the invention remains visually colourless after a period of 6 months. By contrast, the aqueous alcoholic solution containing the untreated cork stoppers appears visually to be yellow in colour after a period of a few days.

1. A device for treating the outside surface of a cork stopper (3), comprising:
a first liquid composition, called a reactive composition (4), comprising:
a composition, called a bi-epoxy composition (5), of at least one compound having a molecular mass of from 340 g/mol to 800 g/mol and having the following general formula (M): 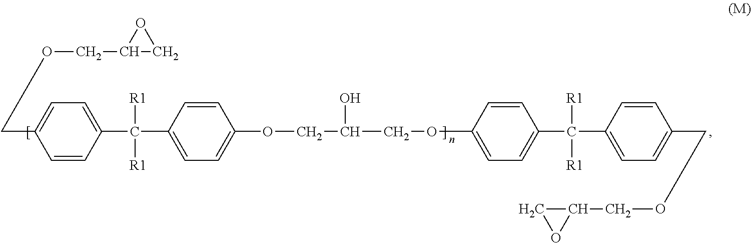
wherein:
n is a natural whole number selected from the group formed of 0, 1 and 2, and
R1 is chosen from the group formed of —H and —CH₃;
a solvent, called a reactive solvent, of the following general formula (N): 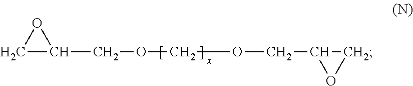
wherein x is a whole number from 2 to 10;
a second liquid composition, called a curing composition (8), comprising at least one polyamine adapted to react with at least one epoxy group of the reactive composition (4) to form a covalent bond between a primary amine of the polyamine and said epoxy group, and to form, by polymerization, a protective film on the surface of the cork stopper (3);
wherein the reactive composition (4) comprises a filler of a solid in the divided state dispersed in the reactive composition (4), said solid in the divided state being formed of barium sulfate in the divided state.

2. The device as claimed in claim 1, wherein the solid in the divided state is formed of particles having a mean diameter of from 0.7 μm to 4 μm.

3. The device as claimed in claim 1, which device is adapted to form, by mixing of the liquid reactive composition (4) and the liquid curing composition (8), a surface treatment mixture (10) in the liquid state having a viscosity of less than 30,000 mPa·s.

4. The device as claimed in claim 1, wherein the curing composition (8) comprises:
a composition, called a non-cyclic aliphatic polyamine composition, of at least one aliphatic polyamine chosen from the group formed of 2,2,4-trimethyl-1,6-hexanediamine and 2,4,4-trimethyl-1,6-hexanediamine;
a composition, called a cyclic aliphatic polyamine composition, of at least one cyclic aliphatic polyamine;
a composition, called a phenalkylamine composition, formed of at least one cardanol derivative of the following general formula (P): 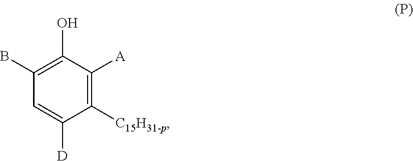
wherein:
p is a whole number chosen from 0, 2, 4 and 6;
A, B and D are groups chosen independently of one another from the group formed of hydrogen (H) and groups having a terminal primary amine and a main chain connecting the phenol group of the cardanol and said terminal primary amine, said main chain being formed of a number of from 5 to 10 of atoms chosen from carbon atoms and nitrogen atoms.

5. The device as claimed in claim 1, wherein the reactive composition (4) comprises a proportion by mass of said solid filler (7) of from 10% to 50%.

6. The device as claimed in claim 1, wherein the reactive composition (4) comprises a composition, called a flexibilizing composition (6), of at least one liquid compound of the following general formula (S): 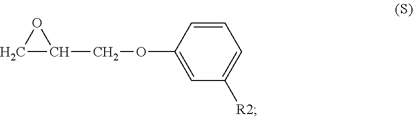
wherein R2 is a hydrocarbon group comprising a main chain having from 10 to 20 carbon atoms.

7. The device as claimed in claim 1, wherein the reactive composition (4) comprises a proportion by mass of less than 5% of amorphous hydrophobic silica in the divided state.

8. The device as claimed in claim 1, wherein the reactive composition (4) comprises a proportion by mass of at least one colouring chosen from the group formed of food colourings.

9. A method for treating the outside surface of a cork stopper (3), in which:
a treatment device according to claim 1 is chosen;
a treatment mixture (10) is formed by mixing (20) an amount by mass of the reactive composition (4) with an amount by mass of the curing composition (8), the ratio between the amount by mass of the reactive composition (4) and the amount by mass of the curing composition (8) in the treatment mixture (10) being from 2 to 10; and then
a step (12) of coating the cork stoppers (3) is carried out, in which said cork stoppers (3) are brought into contact with the treatment mixture (10) with agitation in an agitator drum at ambient temperature for a period of from 15 minutes to 30 minutes so as to form coated stoppers (13); then
a step (11) of polymerization and drying of the treatment mixture (10) is carried out by placing said cork stoppers (3), separately from one another, in atmospheric air and at ambient temperature for a period of at least 24 hours, and adapted to obtain coated stoppers (15) that are ready to use.

10. The method as claimed in claim 9, wherein the cork stoppers (3) being micro-agglomerated cork stoppers (3) for the stoppering of a bottle containing a strong alcohol, there is used an amount of the treatment mixture (10) adapted so that the ratio of the total surface area of the cork stoppers to be treated, expressed in m², and the mass, expressed in grams, of the treatment mixture (10) is from 0.02 to 0.03.

11. The method as claimed in claim 9, wherein the cork stoppers (3) being micro-agglomerated cork stoppers (3) for the stoppering of a bottle containing a still wine, there is used an amount of the treatment mixture (10) adapted so that the ratio of the total surface area of the cork stoppers (3) to be treated, expressed in m², and the mass of the treatment mixture (10), expressed in grams, is from 0.2 to 0.3.

12. The method as claimed in claim 9, wherein, prior to the mixing step (20), a proportion by mass of approximately 5% of a glass filler in the divided state having a particle size of from 50 μm to 100 μm is added to the reactive composition (4).

13. The method as claimed in claim 9, wherein, after the polymerization step (11), the coated cork stoppers (3) are treated with an amount of at least one silicone elastomer in a proportion of 40 g of silicone elastomer to 10,000 coated cork stoppers (3).

14. A coated cork stopper (3) having an outer protective film, wherein said outer protective film comprises a filler of a solid in the divided state, said solid in the divided state being formed of barium sulfate in the divided state.

15. The cork stopper (3) as claimed in claim 14, wherein the outer protective film is free of organic volatile compounds.

16. The device as claimed in claim 2, which device is adapted to form, by mixing of the liquid reactive composition (4) and the liquid curing composition (8), a surface treatment mixture (10) in the liquid state having a viscosity of less than 30,000 mPa·s.

17. The device as claimed in claim 2, wherein the curing composition (8) comprises:
a composition, called a non-cyclic aliphatic polyamine composition, of at least one aliphatic polyamine chosen from the group formed of 2,2,4-trimethyl-1,6-hexanediamine and 2,4,4-trimethyl-1,6-hexanediamine;
a composition, called a cyclic aliphatic polyamine composition, of at least one cyclic aliphatic polyamine;
a composition, called a phenalkylamine composition, formed of at least one cardanol derivative of the following general formula (P): 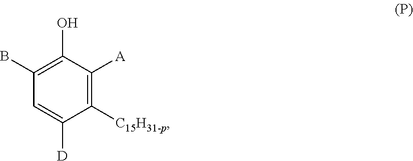
wherein:
p is a whole number chosen from 0, 2, 4 and 6;
A, B and D are groups chosen independently of one another from the group formed of hydrogen (H) and groups having a terminal primary amine and a main chain connecting the phenol group of the cardanol and said terminal primary amine, said main chain being formed of a number of from 5 to 10 of atoms chosen from carbon atoms and nitrogen atoms.

18. The device as claimed in claim 3, which device is adapted to form, by mixing of the liquid reactive composition (4) and the liquid curing composition (8), a surface treatment mixture (10) in the liquid state having a viscosity of less than 30,000 mPa·s.

19. The device as claimed in claim 2, wherein the curing composition (8) comprises:
a composition, called a non-cyclic aliphatic polyamine composition, of at least one aliphatic polyamine chosen from the group formed of 2,2,4-trimethyl-1,6-hexanediamine and 2,4,4-trimethyl-1,6-hexanediamine;
a composition, called a cyclic aliphatic polyamine composition, of at least one cyclic aliphatic polyamine;
a composition, called a phenalkylamine composition, formed of at least one cardanol derivative of the following general formula (P): 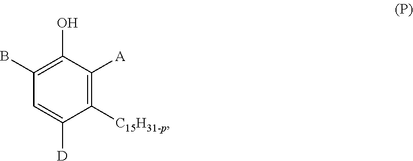
wherein:
p is a whole number chosen from 0, 2, 4 and 6;
A, B and D are groups chosen independently of one another from the group formed of hydrogen (H) and groups having a terminal primary amine and a main chain connecting the phenol group of the cardanol and said terminal primary amine, said main chain being formed of a number of from 5 to 10 of atoms chosen from carbon atoms and nitrogen atoms.

20. The device as claimed in claim 2, wherein the reactive composition (4) comprises a proportion by mass of said solid filler (7) of from 10% to 50%.
